(19) United States
(12) Patent Application Publication
(10) Pub. No.: US 2004/0215474 A1
(43) Pub. Date: Oct. 28, 2004

(54) Method and apparatus for integrating data regarding vehicle events

(76) Inventors: David Nelson, Chicago, IL (US); Walt Tracy, Naperville, IL (US)

Correspondence Address: BUCKLEY, MASCHOFF, TALWALKAR LLC, 5 ELM STREET, NEW CANAAN, CT, 06840, US

(21) Appl. No.: 10/423,854

(22) Filed: Apr. 25, 2003

(51) Int. Cl. G06F 17/60

(52) U.S. Cl. 705/1

(57) ABSTRACT

A system, method, apparatus, means, and computer program that facilitates collection of information regarding vehicle events from one or more revenue control systems. A vehicle event may occur when a vehicle enters a parking facility, a vehicle exits a parking facility, a fee is collected at a parking facility, an alarm is generated at a parking facility, etc. Revenue controls systems may be located at single parking facility or multiple parking facilities. Different revenue control systems may use different hardware/software combinations, provide data in different formats, etc. Vehicle event information can be collected from different revenue control systems in different formats and revenue information can be created in a consistent format based on the vehicle event information.

### CROSS REFERENCE TO RELATED APPLICATION

This application is related to U.S. application Ser. No.______, filed Apr. 25, 2003, entitled “Method and Apparatus for Obtaining Data Regarding a Parking Location”, and is also related to U.S. application Ser. No.______, filed Apr. 25, 2003, entitled “Method and Apparatus for Facilitating Customer Service for a Parking Facility”, the contents of both of which are incorporated herein by reference for all purposes.

### FIELD OF THE INVENTION

The present invention relates to a method and apparatus for processing information regarding one or more vehicle events and, more particularly, embodiments of the present invention relate to methods, means, apparatus, and computer program code for integrating data regarding multiple vehicle events.

### BACKGROUND OF THE INVENTION

A parking facility or parking location may include a point-of-sale (POS) device, computer, a ticket dispenser, card reader, or other revenue control system that may be involved in vehicle activities located at the parking facility or location. For example a revenue control system may be involved when a vehicle enters a parking facility, a vehicle exits a parking facility, a fee is collected at a parking facility, an alarm is generated at a parking facility, etc. Revenue controls systems may be located at a single parking facility or multiple parking facilities. Unfortunately, different revenue control systems may use different hardware/software combinations, provide data in different formats, etc., which makes it difficult to integrate the data.

It would be advantageous to provide a method and apparatus that overcame the drawbacks of the prior art. In particular, it would be desirable to provide a method and apparatus that allowed to obtain information from multiple and/or different revenue control systems and to integrate the data for use by a revenue management system.

### SUMMARY OF THE INVENTION

Embodiments of the present invention provide a system, method, apparatus, means, and computer program code for integrating data regarding one or more vehicle events. A vehicle event may occur when a vehicle enters a parking facility, a vehicle exits a parking facility, a fee is collected at a parking facility, an alarm is generated at a parking facility, etc. Revenue controls systems may be located at single parking facility or multiple parking facilities. Different revenue control systems may use different hardware/software combinations, provide data in different formats, etc. The present invention enables vehicle event information to be collected from different revenue control systems in different formats and the creation of revenue information in a consistent format.

Additional objects, advantages, and novel features of the invention shall be set forth in part in the description that follows, and in part will become apparent to those skilled in the art upon examination of the following or may be learned by the practice of the invention.

According to some embodiments of the present invention, a method for processing information regarding a vehicle event may include detecting first data indicative of a vehicle event; generating second data indicative of a revenue event based on the first data; and providing the second data for use by a revenue management system. In some other embodiments, a method for processing information regarding a vehicle event may include receiving first data in a first format from a first device, the first data being indicative of a first vehicle event; creating second data in a second format, the second data indicative of the first vehicle event; and providing the second data to a second device.

According to some embodiments of the present invention, a system may include a first component adapted to detect first data indicative of a vehicle event based on appearance of a field name in the first data and to obtain the data; and a second component adapted to receive second data from the first component indicative of the vehicle event, create third data indicative of a revenue event created by vehicle event, and provide the third data for use by a revenue management system. In some other embodiments, a system may include a revenue control system adapted to produce data in a first format, the data being indicative of a vehicle event; and a first interface in communication with the revenue control system, the interface adapted to obtain the data from the revenue control system, change the data from the first format to a second format, and provide the data in the second format.

According to some embodiments of the present invention, a system for processing information regarding a vehicle event may include a memory; a communication port; and a processor connected to the memory and the communication port, the processor being operative to: detect first data indicative of a vehicle event; generate second data indicative of a revenue event based on the first data; and provide the second data for use by a revenue management system. In some other embodiments, a system for processing information regarding a vehicle event may include a memory; a communication port; and a processor connected to the memory and the communication port, the processor being operative to: receive first data in a first format from a first device, the first data being indicative of a first vehicle event; create second data in a second format, the second data indicative of the first vehicle event; and provide the second data to a second device.

According to some embodiments, a computer program product in a computer readable medium for processing information regarding a vehicle event may include first instructions for identifying detecting first data indicative of a vehicle event; second instructions for creating second data indicative of a revenue event based on the first data; and third instructions for sending the second data for use by a revenue management system. In some other embodiments, a computer program product in a computer readable medium for processing information regarding a vehicle event may include first instructions for obtaining first data in a first format from a first device, the first data being indicative of a first vehicle event; second instructions for creating second data in a second format, the second data indicative of the first vehicle event; and third instructions for sending the second data to a second device.

According to some embodiments, an apparatus for processing information regarding a vehicle event may include means for identifying detecting first data indicative of a vehicle event; means for creating second data indicative of a revenue event based on the first data; and means for sending the second data for use by a revenue management system. In some other embodiments, an apparatus for processing information regarding a vehicle event may include means for obtaining first data in a first format from a first device, the first data being indicative of a first vehicle event; means for creating second data in a second format, the second data indicative of the first vehicle event; and means for sending the second data to a second device.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a block diagram of system components illustrating one embodiment of an apparatus usable with the methods of present invention;

FIG. 2 is a flowchart of a first embodiment of a method in accordance with the present invention;

FIG. 3 is a flowchart of a second embodiment of a method in accordance with the present invention;

FIG. 4 is another block illustrating system components for one embodiment of an apparatus usable with the methods of the present invention;

FIG. 5 is a block diagram illustrating one embodiment of a configuration of the RCS interface or listener of FIG. 1; and

FIG. 6 is a table illustrating one possible implementation of the vehicle event database of FIG. 5.

### DETAILED DESCRIPTION

Applicants have recognized that there is a market opportunity for systems, means and methods that facilitates collection of information regarding vehicle events from one or more revenue control systems. In some embodiments, a vehicle event may occur when a vehicle enters a parking facility, a vehicle exits a parking facility, a fee is collected at a parking facility, an alarm is generated at a parking facility, etc. Revenue controls systems may be located at single parking facility or multiple parking facilities. Different revenue control systems may use different hardware/software combinations, provide data in different formats, etc. The present invention enables vehicle event information to be collected from different revenue control systems in different formats and the creation of revenue information in a consistent format based on the vehicle event information. These and other features will be discussed in further detail below, by describing a system, individual devices, and processes according to embodiments of the invention.

System

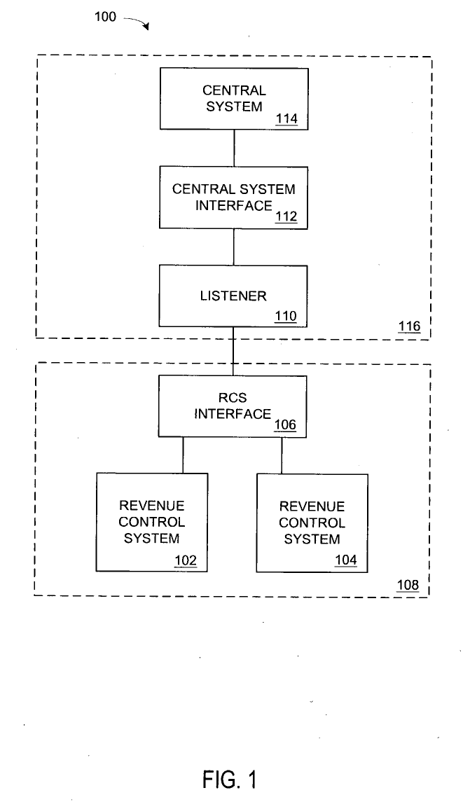

Now referring to FIG. 1, an apparatus or system 100 usable with the methods disclosed herein is illustrated. The system 100 may include one or more revenue control systems (RCS) 102, 104 located at the same or different parking locations of facilities. The system 100 also may include an RCS interface 106 directly or indirectly in communication with the revenue control systems 102, 104 and receives vehicle event information from the revenue control systems 102, 104. The RCS interface 106 may be located at the same parking location or facility as the revenue control systems 102, 104, as indicated by box 108. The system 100 may include a listener device 110 that receives vehicle event information from the RCS interface 106 and a central system interface 112 that takes information regarding vehicle events received from the listener 110 and formats the information for use by the central system 114. In some embodiments, the listener 110, central system interface 112, and central system 114 may be located at the same location, as indicated by box 116. The devices shown in FIG. 1 need not be in constant communication. For example, the revenue control system 102 may communicate with the RCS interface 106 only when such communication is appropriate or necessary.

In some embodiments, a revenue control system may be or include a point-of-sale (POS) device, computer, pay station, ticket dispenser, card reader, or other hardware/software combination or device located at a parking facility. For example, a person exiting a parking facility may pay a cashier at the parking facility with cash. The cashier may use a POS device or system to scan a ticket to determine the amount due by the person for parking at the facility. As another example, a person may insert coins or dollar bills into a dispenser that can provide a ticket or sticker that allows the person to park in a facility for a given period of time. As a third example, an exit of a parking facility may have a card reader that can scan a card presented by a person upon leaving the parking facility. Upon a proper scanning of a valid card, a gate may raise at the exit, thereby allowing the person to leave the parking facility.

A revenue control system may create a vehicle event message and provide the message the RCS interface 106. Different revenue control systems may provide different information to the RCS interface 106 regarding a vehicle event. In addition, different revenue control systems may provide a vehicle event message in different formats to the RCS interface 106.

In some embodiments, the RCS interface 106 may be implemented in hardware and/or software. For example, the RCS interface 106 may include or be operating on a server, mainframe, or other computer that can receive vehicle event messages from a revenue control system. While the RCS interface 106 illustrated in FIG. 1 is connected to or in communication with the two revenue control systems 102, 104, in other embodiments the RCS interface 106 may be connected to or in communication with a fewer or greater number of revenue control systems.

The RCS interface 106 will receive vehicle event messages from one or more revenue control systems. The RCS interface 106 may extract relevant information from a vehicle event message and use the data to create a new message regarding the vehicle event. The new message may use a predefined or designated format in order to provide consistent messages regarding vehicle events to the listener 110. In addition, in some embodiments, the RCS interface 106 may provide other messages to the listener 110.

In some embodiments, the listener 110 may be implemented in hardware and/or software. For example, the listener 110 may include or be operating on a server, mainframe, or other computer that can receive messages from the RCS interface 106. While the listener 110 illustrated in FIG. 1 is connected to or in communication with the one RCS interface 106, in other embodiments the listener 110 may be connected to or in communication with more than one RCS interface.

The listener 110 may be to view, monitor or receive messages from the RCS interface 106 and/or other devices. For example, the listener 110 may be implemented in software operating on a device. Messages from one or more RCS interfaces and possibly other devices may pass through or be received by the device. As the listener 110 is interested in messages from the RCS interface 106 regarding vehicle events, the listener 110 may ignore messages that are not from the RCS interface 106 and/or that do not relate to vehicle events. For example, the listener 110 may ascertain whether or not a message includes information regarding an in time, out time, payment amount, or payment method associated with a vehicle parking in parking facility. When the listener 110 detects a message from the RCS interface 106 regarding a vehicle event, the listener 110 may extract the data regarding the vehicle event from the message and pass some or all of the information to the central system interface 112.

In some embodiments, the listener 110 and the RCS interface 106 may communicate via a messaging server (not shown) that may be part of the apparatus 100. The messaging server may receive messages from multiple RCS interfaces 106 and/or other hardware/software components and forward some or all of the messages to the listener 110 and/or other devices or hardware/software components.

In some embodiments, the central system interface 112 may be implemented in hardware and/or software. For example, the central system interface 112 may include or be operating on a server, mainframe, or other computer that can receive messages from the listener 110. Alternatively, in some embodiments, the central system interface 112 may be operating on or as part of the same device or hardware/software combination that implements the listener 110 or the central system 114.

The central system interface 112 may receive vehicle event data from the listener 110 and translate, reformat, modify, etc. the data to create a revenue event message that is usable by the central system 114. Different central systems may require information to be provided to them in different formats. In addition, different central systems may use different types or pieces of information, use different revenue management software applications, etc.

In some embodiments, the central system 114 may be implemented in hardware and/or software. For example, the central system 114 may include or be operating on a server, mainframe, work station, or other computer. The central system 114 may include or operate one or more revenue management applications or other software suitable for collecting and maintaining revenue information regarding one or more parking facilities.

Many different types of implementations or hardware configurations can be used in the system 100 and with the methods disclosed herein and the methods disclosed herein are not limited to any specific hardware/software configuration for the system 100 or any of its components.

In some embodiments, one or more of the components of the system 100 may communicate via one or more communications networks. In some embodiments, a communications network might be or include the Internet, the World Wide Web, or some other public or private computer, cable, telephone, client/server, peer-to-peer, or communications network or intranet. A communications network also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. Moreover, as used herein, communications may include those enabled by wired or wireless technology.

Process Description

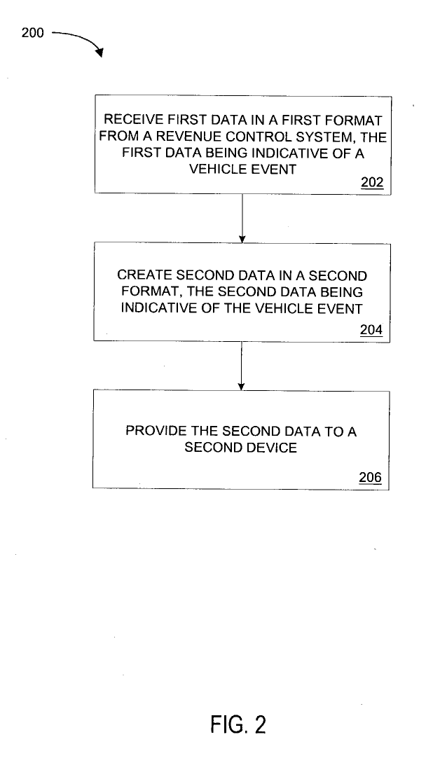

Reference is now made to FIG. 2, where a flow chart 200 is shown which represents the operation of a first embodiment of the present invention. The particular arrangement of elements in the flow chart 200 is not meant to imply a fixed order to the steps; embodiments of the present invention can be practiced in any order that is practicable. In some embodiments, some or all of the steps of the method 200 may be performed or completed by the RCS interface 106, as will be discussed in more detail below.

Processing begins at a step 202 during which time the RCS interface 106 receives data from a revenue control system (e.g., the revenue control system 102). A revenue control system may provide vehicle event data to the RCS interface 106 in a variety of formats or communication channels such as, for example, an XML (Extensible Markup Language) transmission, a spreadsheet (e.g., Microsoft Excel™ software) file, a word processor file, a text file, an HTML (HyperText Markup Language) transmission, an instant message communication, an email message, etc. Thus, the RCS interface 106 may be programmed, configured, or otherwise set up to accept or receive vehicle event data in a format for the revenue control system 102 that is different than the format for the revenue control system 108.

A revenue control system may generate a vehicle event message each time a vehicle event occurs. In some embodiments, a vehicle event may occur when a vehicle enters a parking facility, a vehicle exits a parking facility, a fee is collected at a parking facility, an alarm is generated at a parking facility, etc. For example, a person entering a parking facility with a vehicle may provide a cash or credit card payment at an entry device (e.g., a revenue control system) that allows entry into the parking facility (e.g., raises a gate upon payment). The entry device may send an email message or other transmission to the RCS interface 106 providing information such as the time/date of the entry, the amount of the payment, the type of payment, an identifier associated with the parking facility, an identifier associated with the entry device, an identifier associated with the vehicle event, the parking rate(s) in effect, the length of time of parking the person has paid for via the entry device, an identifier of any ticket or sticker associated dispensed by the entry device, etc.

As another example, a person exiting a parking facility with a vehicle may swipe a magnetic card across a card reader. If the card is valid, an exit gate may open to allow the person to drive the vehicle out of the parking facility. The card reader and the exit gate may form part of or be connected to a revenue control system. The revenue control system may provide an XML transmission to the RCS interface 106 providing information such as the time/date of the exit, an identifier associated with the parking facility, an identifier associated with the revenue control system, an identifier associated with the vehicle event, an identifier associated with the card, the parking rate(s) in effect, an identifier associated with a vendor that provided some or all of the revenue control system, etc.

As another example, a person exiting a parking facility with a vehicle may present a ticket to a cashier, the ticket being used to determine how long the vehicle was parked at the parking facility and the amount due by the person. The cashier may use a POS system (e.g., a revenue control system) that reads the ticket, determines the amount due, and assists the cashier in conducting the transaction. The POS system may send a text file or other transmission to the RCS interface 106 providing information such as the time/date of the entry, the amount of the payment due, the type of payment, an identifier associated with the parking facility, an identifier associated with the POS system, an identifier associated with the cashier, an identifier associated with the vehicle event, an identifier associated with the ticket, the amount of any applicable discount (if any), the type of applicable discount (if any), the parking rate(s) in effect, an identifier of the a vendor that supplied the POS system, etc.

During a step 204, the RCS interface 106 takes the data received from a revenue control system during the step 202 and reformats some or all of the data into a new specific format. Thus, regardless of the format or communication channel used by a revenue control system to send vehicle event information to the RCS interface 106, the RCS interface uses some or all of the data to create a new message or transmission using a designated format. Thus, the new message or transmission can be created independently of the revenue control system that provided the vehicle event data on which the new message or transmission is based.

In some embodiments, the RCS 106 may create a message using XML format and some or all of the data received during the step 202. The XML message may include many different fields, such as the following:

A vendor attribute that may be used to designate the vendor of the RCS interface 106 from which the XML message originated.

A batch number attribute that may be used to identify the XML message. The RCS interface may include information regarding multiple vehicle events into a single XML message.

A location descriptor attribute that may be used indicate RCS interface 106 that generated the XML message. Different RCS interfaces may have the same location attribute (e.g., if they are implemented in the same hardware/software combination).

A site identifier attribute that may be used to describe the RCS interface 106 that generated the XML message and may be unique across all parking facilities. Thus, different RCS interfaces may have different site identifier attributes.

A batch size count that identifies the number of vehicle event records for the XML message.

A vehicle event identifier that may be assigned by a revenue control system to a vehicle event. In some embodiments, a revenue control system may not be allowed to use the same vehicle event identifier more than once during a specified time period (e.g., not more than once per day).

A vehicle event type that describes the type of vehicle event (e.g., vehicle entry into a parking facility, vehicle exit from a parking facility, payment received).

A vehicle event source identifier that may identify the lane or station where the vehicle event occurred.

Date and/or time information that breaks down when a vehicle event took place

Year—Four digit year

Month—1 or 2 digit month

Day of month—1 or 2 digit day of the month

Hour—1or 2 digit hour (24 hour format)

Minute—1 or 2 digit minute

Second—1or 2 digit second

A card ticket number that may include the number of the ticket issued by a ticket dispenser or other revenue control system for a transient parker, or the number of the access keycard for a monthly parker presented at a revenue control system.

A gross amount number that represents the total gross sales amount for a parking transaction.

A net amount number that represents the total net sales amount for a parking transaction (e.g., net amount equals gross amount minus any applicable discounts).

An event reason indicator that describes or indicates why a parking ticket would be voided for a parking transaction. For example, the person parking may be an employee, a monthly parker, etc. who does not have to pay each time entering or exiting a parking facility, even if provided a ticket.

A rate code attribute that might indicate the rate or rate schedule applicable to a parking transaction. In some cases, multiple rates or rate schedules might apply to a single vehicle event.

A method of payment Attribute that indicates the method of payment used for a parking transaction (e.g., cash, check, credit card).

In some embodiments, the RCS interface 106 may used different identifiers or numbers for fields in different XML messages for different revenue control systems, different parking locations, different vendors, etc., even though the fields used in the different XML messages are the same. For example, some revenue control systems might provide more or less level of detail for different aspects of vehicle event, use different type descriptors for different vehicle events, etc.

One example XML message that may be generated by the RCS interface 106 is provided below.

```
- <Message>
  - <Batch vendor=“PARKDATAINC” BatchNumber=“61993”
      LocationDescriptor=“CH130” SiteID=“CH130”>
    - <VehicleEvent>
        <EventID>90031</EventID>
        <EventType>3002</EventType>
        <Source>1</Source>
      - <EventDetails>
            <CardTktNumber>92145671</CardTktNumber>
          <Sale RateCode=“8”>10.00</Sale>
          <Sale RateCode=“9”>15.00</Sale>
          <Payment
              MethodOfPayment=“CASH”>25.00</Payment>
          <GrossAmount>25.00</GrossAmount>
          <NetAmount>25.00</NetAmount>
        </EventDetails>
      - <DateTime>
          <Year>2001</Year>
          <Month>11</Month>
          <DayOfMonth>01</DayOfMonth>
          <Hour>15</Hour>
          <Minute>30</Minute>
          <Second>2</Second>
        </DateTime>
    </VehicleEvent>
  </Batch>
</Message>
```

In some embodiments, the message created by the RCS interface 106 during the step 204 may include information regarding the date/time a vehicle entered (or tried to enter) a parking facility, the date/time the vehicle exited (or tried to exit) a parking facility, the amount of time a vehicle was parked in a parking facility, and/or other information.

In some embodiments, the RCS interface 106 conduct the step 204 only at designated times and/or only at designate intervals. For example, the RCS interface 106 may create a message only every three hours, the message including information regarding all vehicle event messages received by the RCS interface 106 during the previous three hours.

During a step 206, the RCS interface 106 may provide the message created during the step 204 to another device. For example, the RCS interface 106 may provide the message to the listener 110. In some embodiments, the RCS interface 106 conduct the step 206 only at designated times and/or only at designate intervals. For example, the RCS interface 106 may send messages directly or indirectly to the listener 110 only every three hours. Each message may include information regarding multiple vehicle events.

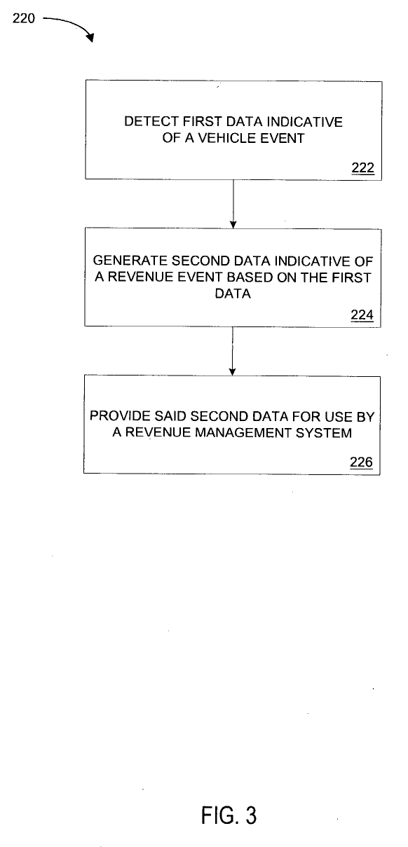

Reference is now made to FIG. 3, where a flow chart 220 is shown which represents the operation of a second embodiment of the present invention. The particular arrangement of elements in the flow chart 220 is not meant to imply a fixed order to the steps; embodiments of the present invention can be practiced in any order that is practicable. In some embodiments, some or all of the steps of the method 220 may be performed or completed by the listener 110 or the listener in conjunction with the central system interface 112.

Processing begins at a step 222 during which the listener 110 detects data indicative of a vehicle event. As previously discussed above, the listener 110 may receive messages directly or indirectly that were generated by the RCS interface 106.

In some embodiments, the listener 110 may receive or monitor only vehicle event related messages created by one or more RCS interfaces. In other embodiments, the listener 110 may receive or monitor various kinds of messages. The listener 110 may ascertain if a message includes a field or data relating to a vehicle event. For example, the listener 110 may look to see if an XML message contains one or more fields such as a method of payment field, an event source field, a payment amount, etc., that indicates that the message relates to a vehicle event.

During a step 224, data is generated indicative of a revenue event based on some or all of the data detected during the step 222. In some embodiments, the listener 110 may generate new data or other transmission based on the data detected during the step 222 and provide the data to the central system interface 112. The data may be a new XML document or may be in some other format. The data may represent a revenue event created by a vehicle event. For example, the data may indicate the amount and type of payment received and the parking facility or other location where the payment was received. Other detailed revenue data may include, for example, location specific information or location dependent information. Since the information indicated in the data may relate primarily to revenue issues, in some embodiments, the data generated during the step 224 may not include all of the information received by the listener 110 from the RCS interface 106. The central system 114 or other revenue management system that receives the data may not need all of the other information regarding the vehicle event. In other embodiments, the second data created during the step 224 may include some or all of the data detected during the step 222, and the second data may be in the same format as the data detected during the step 222.

During a step 226, the listener 110 may forward the second data created during the step 224 to the central system interface 112. In some embodiments, the listener 110 may provide the data to the central system interface in a different format, using different fields, or in an otherwise different manner than the listener received the data from the RCS interface 106.

Upon receiving the data from the listener 110, the central system interface 112 may provide some or all of the data to the central system 114. Thus, in some embodiments, the steps 224 and/or 226 may be conducted by a combination of the listener 110 and the central system interface 112. The central system interface 112 may function as a staging area to hold revenue information prior to entry into the central system 114. For example, in some embodiments the central system 114 may accept revenue data only at certain times or during certain windows of time. The central system interface 112 may store or hold revenue information until the central system 114 is ready or able to receive the information.

In some embodiments, the central system interface 112 may extract revenue information received from the listener 110 and provide it to the central system 114 in a format preferred or required by the central system. Different central systems, or different applications operating on the same or different central systems, may want the data from the central system interface 112 to be present in a specific format or manner, used different fields, etc.

In some embodiments, the central system 114 may include one or more revenue management applications, databases, etc. In addition, the central system 114 may include an application that extracts revenue data from messages received from the central system interface 112 and uses the data to populate a database, provide entries to one or more revenue management applications, etc.

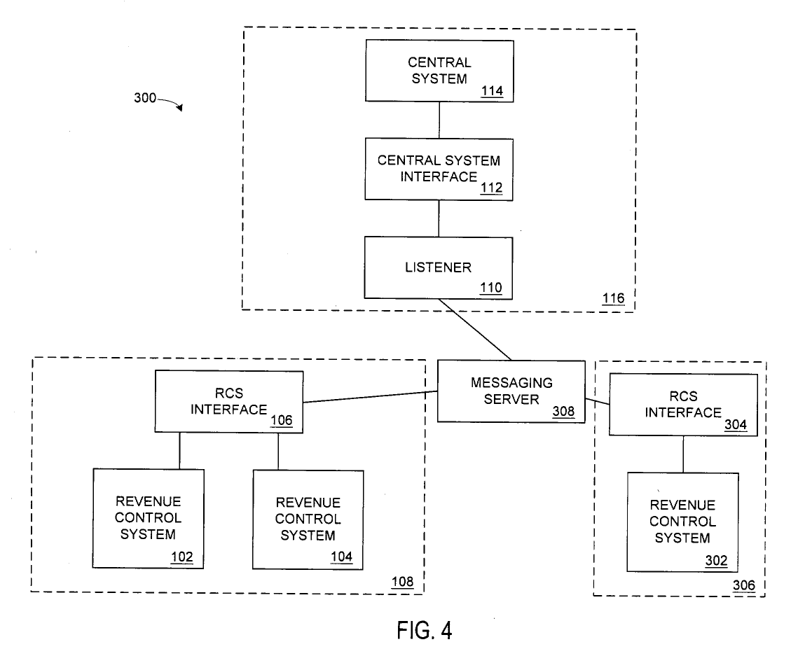

Now referring to FIG. 4, a second embodiment 300 of a system in accordance with the present invention is illustrated. The system 300 includes the components in the apparatus 100. In addition, the system includes a revenue control system 302 and a RCS interface 304 located at a different location (e.g., a different parking facility as represented by box 306) than the revenue control systems 102, 104 and the RCS interface 106. The revenue control system 302 may generate vehicle event messages in a manner similar to that of the revenue control systems 102, 104 previously described above and provide them to the RCS interface 304. The RCS interface 304 may create a new message (e.g., an XML transmission) that describes a vehicle event message received from the revenue control generator 302 and provide the message to the messaging server 308 or directly to the listener 110. The messaging server 308 also may receive messages from the RCS interface 106 and provide them to the listener 110 and/or to other devices or applications.

RCS Interface/Listener

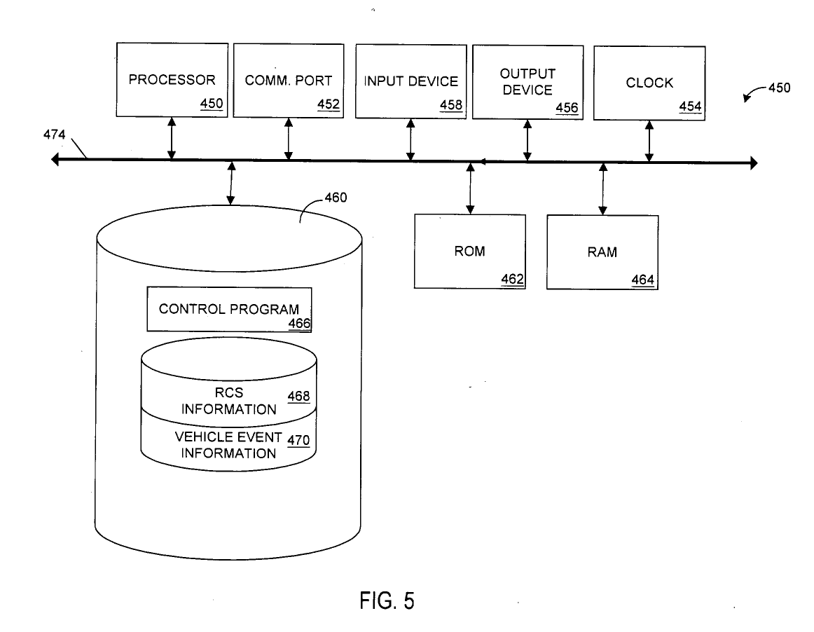

Now referring to FIG. 5, a representative block diagram of a device 450 that may implement or operate as some or all of the RCS interface 106 or the listener 110 is illustrated. The device 450 may include a processor, microchip, central processing unit, or computer 450 that is in communication with or otherwise uses or includes one or more communication ports 452 for communicating with user devices and/or other devices. Communication ports may include such things as local area network adapters, wireless communication devices, Bluetooth technology, etc. The device 450 also may include an internal clock element 454 to maintain an accurate time and date for the device 450, create time stamps for messages or other communications received or sent by the device 450, etc.

If desired, the device 450 may include one or more output devices 456 such as a printer, infrared or other transmitter, antenna, audio speaker, display screen or monitor, text to speech converter, etc., as well as one or more input devices 458 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the device 450 may include a memory or data storage device 460 to store information, software, databases, messages or other communications, device drivers, etc. The memory or data storage device 460 preferably comprises an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The device 450 also may include separate ROM 462 and RAM 464.

The processor 450 and the data storage device 460 in the device 450 each may be, for example: (i) located entirely within a single computer or other computing device; or (ii) connected to each other by a remote communication medium, such as a serial port cable, telephone line or radio frequency transceiver. In one embodiment, the device 450 may comprise one or more computers that are connected to a remote server computer for maintaining databases.

A conventional personal computer or workstation with sufficient memory and processing capability may be used as the device 450. In one embodiment, the device 450 operates as or includes a Web server for an Internet environment. The device 450 preferably is capable of high volume transaction processing, performing a significant number of mathematical calculations in processing communications and database searches. A Pentium™ microprocessor, such as the Pentium III™ or IV™ microprocessor manufactured by Intel Corporation, may be used for the processor 450. Equivalent processors are available from Motorola, Inc., AMD, or Sun Microsystems, Inc. The processor 450 also may comprise one or more microprocessors, computers, computer systems, etc.

Software may be resident and operating or operational on the device 450. The software may be stored on the data storage device 460 and may include a control program 466 for operating the server, databases, etc. The control program 466 may control the processor 450. The processor 450 preferably performs instructions of the control program 466, and thereby operates in accordance with the present invention, and particularly in accordance with the methods described in detail herein. The control program 466 may be stored in a compressed, uncompiled and/or encrypted format. The control program 466 furthermore includes program elements that may be necessary, such as an operating system, a database management system and device drivers for allowing the processor 450 to interface with peripheral devices, databases, etc. Appropriate program elements are known to those skilled in the art, and need not be described in detail herein.

The device 450 also may include or store information regarding parking facilities, revenue control systems, RCS interfaces, revenue management systems, vehicle events, vendors, parking transactions, communications, etc. For example, information regarding one or more vehicle events may be stored in a vehicle event information database 468 for use by the device 450 or another device or entity. In some embodiments, some or all of one or more of the databases may be stored or mirrored remotely from the device 450.

According to an embodiment of the present invention, the instructions of the control program may be read into a main memory from another computer-readable medium, such as from the ROM 462 to the RAM 464. Execution of sequences of the instructions in the control program causes the processor 450 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 450, communication port 452, clock 454, output device 456, input device 458, data storage device 460, ROM 462, and RAM 464 may communicate or be connected directly or indirectly in a variety of ways. For example, the processor 450, communication port 452, clock 454, output device 456, input device 458, data storage device 460, ROM 462, and RAM 464 may be connected via a bus 472.

While specific implementations and hardware configurations for the device 450 has been illustrated, it should be noted that other implementations and hardware configurations are possible and that no specific implementation or hardware configuration is needed. Thus, not all of the components illustrated in FIG. 5 may be needed for a device implementing one or more of the methods disclosed herein.

Database

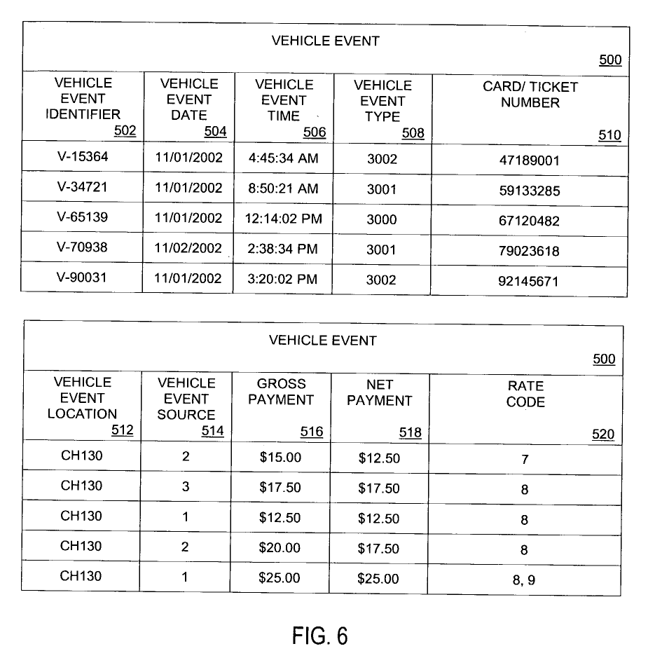

As previously discussed above, in some embodiments the RCS interface 106, the listener 110 or some other component of the system 100 may include or access a database for storing or keeping information regarding one or more vehicle events. One representative vehicle event information database 500 is illustrated in FIG. 6.

The vehicle information database 500 may include a vehicle identifier field 502 that may include codes or other identifiers for one or more vehicle events, a vehicle event date field 504 and a vehicle event time field 506 that may include date and time information for the vehicle events identified in the field 502, a vehicle event type field 508 that may include type identifiers or descriptions for the vehicle events identified in the field 502, a card/ticket number field 510 that may include the numbers for the tickets or cards involved in the vehicle event field 502, a vehicle event location field 512 that may include codes or other identifiers for the location where the vehicle events occurred, a vehicle source identifier field 514 that may include codes or other identifiers for revenue control systems or other equipment involved in the vehicle event or producing a vehicle event message, a gross payment field 516 that may include information regarding the gross payments associated with the vehicle events identified in the field 502, a net payment field 518 that may include information regarding the net payments associated with the vehicle events identified in the field 502, and a rate or rate schedule identifier field 520 that may include information regarding the rates or rate schedules applied to the vehicle events identified in the field 502. In other embodiments, other or different fields also may be used in the vehicle event information database 500.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

1. A method for processing information regarding a vehicle event, comprising:
detecting first data indicative of a vehicle event;
generating second data indicative of a revenue event based on said first data; and
providing said second data for use by a revenue management system.

2. The method of claim 1, wherein said detecting first data indicative of a vehicle event includes checking incoming data for at least one designated field name.

3. The method of claim 2, wherein said detecting first data indicative of a vehicle event includes receiving said incoming data.

4. The method of claim 3, wherein said receiving said incoming data includes receiving said incoming data in an Extensible Markup Language complaint format.

5. The method of claim 1, wherein said first data includes data indicative of at least one of the following:
a vehicle time in associated with said vehicle event; and
a vehicle time out associated with said vehicle event.

6. The method of claim 1, wherein said first data includes data indicative of at least one of the following:
a method of payment associated with said vehicle event; and
a piece of equipment associated with said vehicle event.

7. The method of claim 1, wherein said first data includes data indicative of at least one of the following:
a ticket number associated with said vehicle event; and
an event source identifier associated with said vehicle event.

8. The method of claim 1, wherein said first data includes data indicative of at least one of the following:
a gross monetary amount associated with said vehicle event;
a discount monetary amount associated with said vehicle event; and
a net monetary amount associated with said vehicle event.

9. A method for processing information regarding a vehicle event, comprising:
receiving first data in a first format from a first device, said first data being indicative of a first vehicle event;
creating second data in a second format, said second data indicative of said first vehicle event; and
providing said second data to a second device.

10. The method of claim 9, further comprising:
receiving third data in a third format from a third device, said third data being indicative of a second vehicle event;
creating fourth data in said second format, said fourth data indicative of said second vehicle event; and
providing said fourth data to said second device.

11. The method of claim 9, wherein said second format is Extensible Markup Language protocol compliant.

12. The method of claim 11, wherein said first format is Extensible Markup Language protocol compliant.

13. The method of claim 9, wherein said first data includes data indicative of at least one of the following:
a vehicle time in associated with said vehicle event; and
a vehicle time out associated with said vehicle event.

14. The method of claim 9, wherein said first data includes data indicative of at least one of the following:
a method of payment associated with said vehicle event; and
a piece of equipment associated with said vehicle event.

15. The method of claim 9, wherein said first data includes data indicative of at least one of the following:
a ticket number associated with said vehicle event; and
an event source identifier associated with said vehicle event.

16. The method of claim 9, wherein said first data includes data indicative of at least one of the following:
a gross monetary amount associated with said vehicle event;
a discount monetary amount associated with said vehicle event; and
a net monetary amount associated with said vehicle event.

17. The method of claim 9, further comprising:
receiving third data in a third format from said second device;
creating fourth data in a fourth format based on said third data; and
providing said fourth data to said first device.

18. The method of claim 17, wherein said third data is indicative of a rate change.

19. A system, comprising:
a first component adapted to detect first data indicative of a vehicle event based on appearance of a field name in said first data and to obtain said data; and
a second component adapted to receive second data from said first component indicative of said vehicle event, create third data indicative of a revenue event created by vehicle event, and provide said third data for use by a revenue management system.

20. A system, comprising:
a revenue control system adapted to produce data in a first format, said data being indicative of a vehicle event; and
a first interface in communication with said revenue control system, said interface adapted to obtain said data from said revenue control system, change said data from said first format to a second format, and provide said data in said second format.

21. The system of claim 20, further comprising:
a first device adapted to receive said data in said second format from said first interface, detect said data based on content in said data, and provide at least a portion of said data to a second interface.

22. The system of claim 21, said second interface adapted to produce data indicative of a revenue event based on said data indicative of a vehicle event.

23. The system of claim 22, further comprising:
a second device adapted to receive said data indicative of a revenue event from said second interface.

24. A system for processing information regarding a vehicle event, comprising:
a memory;
a communication port; and
a processor connected to said memory and said communication port, said processor being operative to:
detect first data indicative of a vehicle event;
generate second data indicative of a revenue event based on said first data; and
provide said second data for use by a revenue management system.

25. A computer program product in a computer readable medium for processing information regarding a vehicle event, comprising:
first instructions for identifying detecting first data indicative of a vehicle event;
second instructions for creating second data indicative of a revenue event based on said first data; and
third instructions for sending said second data for use by a revenue management system.

26. A system for processing information regarding a vehicle event, comprising:
a memory;
a communication port; and
a processor connected to said memory and said communication port, said processor being operative to:
receive first data in a first format from a first device, said first data being indicative of a first vehicle event;
create second data in a second format, said second data indicative of said first vehicle event; and
provide said second data to a second device.

27. A computer program product in a computer readable medium for processing information regarding a vehicle event, comprising:
first instructions for obtaining first data in a first format from a first device, said first data being indicative of a first vehicle event;
second instructions for creating second data in a second format, said second data indicative of said first vehicle event; and
third instructions for sending said second data to a second device.
